(19) United States
(12) Patent Application Publication
(10) Pub. No.: US 2009/0185036 A1
(43) Pub. Date: Jul. 23, 2009

(54) REMOTE IN-GROUND RETRACTABLE COMMUNICATION SYSTEM

(76) Inventor: Julian Bowron, Toronto (CA)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/301,393

(22) PCT Filed: May 18, 2007
(86) PCT No.: PCT/CA2007/000901

§ 371 Date: Jan. 8, 2009

Related U.S. Application Data
(60) Provisional application No. 60/801,062, filed on May 18, 2006.

(51) Int. Cl. H04N 7/18

(52) U.S. Cl. 348/151; 340/5.8; 348/E05.024

(57) ABSTRACT

The present invention provides a communication system for covertly monitoring a target area. The communication system comprises a retractable communication unit suitable for in ground installation at a first site, said retractable communication unit comprising: a telescoping support; a communication device mounted on a distal portion of said telescoping support; and a housing comprising a sleeve having a lid on a distal portion of the sleeve, said lid movable between an closed position and an open position, said housing enclosing said telescoping support and said communication device when said telescoping support is in a retracted position. The present invention further provides methods of installing said communication system and methods for using the communication system for covertly monitoring a target area.

### FIELD OF THE INVENTION

The present invention relates to a communication system for discrete surveillance of a target area.

### BACKGROUND OF THE INVENTION

Remotely monitoring a target area often requires deploying a communication system in areas in order to decrease the physical risk of surveillance. However, there remains a risk of damage to the system due to environmental factors or hostile activities.

The present invention provides an improved remote communication system that lowers the risk of detection and the risk of damage to the communication system, and allows for rapid deployment of the system.

### BRIEF SUMMARY OF THE INVENTION

The present invention provides a remote communication system for covertly monitoring activity in a target area.

In one aspect, provided is a communication system comprising a retractable communication unit suitable for in ground installation at a first site, said retractable communication unit comprising: a telescoping support; a communication device mounted on a distal portion of said telescoping support; and a housing comprising a sleeve having a lid on a distal portion of the sleeve, said lid movable between an closed position and an open position, said housing enclosing said telescoping support and said communication device when said telescoping support is in a retracted position.

In an embodiment of the invention, the housing is water resistant and/or dust resistant.

In an embodiment of the invention, the sleeve comprises a first sleeve and a second sleeve, wherein the second sleeve is nested within the first sleeve.

In an embodiment of the invention, the retractable communication unit further comprises an actuating system for moving said telescoping support upward relative to the housing, between a retracted position and an extended position.

In a further embodiment of the invention, the actuating system moves the second sleeve relative to the first sleeve, between a retracted position and an extended position.

In a further embodiment of the invention, the actuating system is a piston.

In a further embodiment of the invention, the piston is a dual stage piston for moving the telescoping support and the second sleeve independently.

In a further embodiment of the invention, the actuating system comprises a screw jack comprising a screw mounted in said housing and extending into an opening in the telescoping support, a motor assembly for rotating said screw, and a plurality of nuts, each mounted on an extendible portion of said telescoping support, wherein each nut departs the screw when the extendible portion on which it is mounted reaches a limit of extension.

In an embodiment of the invention, a collar is attached to a distal portion of the second sleeve, said collar sized and configured to transport foreign matter away from the system during extension of the second sleeve from the retracted position to the extended position.

In a further embodiment of the invention, the collar comprises at least one seal disposed around an outer surface of the collar, said seal having a tapered profile, said profile tapering upward towards the distal end of the collar.

In another embodiment of the invention, the lid comprises an adhesive layer applied to an outer surface of the lid.

In a further embodiment of the invention, the adhesive layer is in the form of a double-sided adhesive tape, one side of said tape affixed to said outer surface of said lid.

In a further embodiment of the invention, the lid comprises first and second portions, wherein each portion is opposably hinged to a distal portion of the housing.

In a further embodiment of the invention, the first and second portions are configured to move outwardly in opposing directions to actuate the lid to the open position.

In another embodiment of the invention, the retractable communication unit further comprises a cover secured over the communication unit.

In a further embodiment of the invention, the cover is sized and configured to transport foreign material away from the system during extension of the telescoping support from the retracted position to the extended position.

In a further embodiment of the invention, the cover is conical in shape and having a lower edge extending beyond the communication unit.

In another embodiment of the invention, the communication unit comprises a camera.

In a further embodiment of the invention, the camera is a video camera.

In a further embodiment of the invention, the camera is a pan-tilt-zoom (PTZ) integrated robotic video camera.

In a further embodiment of the invention, the camera is an infra-red camera.

In an embodiment of the invention, the retractable communication unit further comprises an illuminator mounted to the distal end of the telescoping support.

In a further embodiment of the invention, the illuminator is an infra-red illuminator.

In an embodiment of the invention, the communication device further comprises a two-way communication system

In a further embodiment of the invention, the two-way communication system is a two-way radio system.

In an embodiment of the invention, the communication device further comprises one or more of a key pad unit, a retina reader unit, a fingerprint reader unit or a card reader unit.

In an embodiment of the invention, the system further comprises a tamper alarm.

In a further embodiment of the invention, the tamper alarm is located on the housing.

In an embodiment of the invention, the system further comprises at least one data collection unit located at a second site, wherein each data collection unit comprises: an acoustic sensor coupled to a sensor pad for measuring an acoustic signal within a predetermined range of frequencies; a processor connected to the acoustic sensor for receiving measured acoustic data; a wireless transmitter connected to the processor for communicating the measured acoustic data to a wireless receiver located at the first site.

In an embodiment of the invention, each data collection unit is enclosed within a camouflaged housing.

In an embodiment of the invention, the system further comprises a wireless receiver located at the first site for receiving measured acoustic data transmitted from the wireless transmitter of the data collection unit.

In an embodiment of the invention, the system further comprises a coordinate generating unit located at the first site; said coordinate generating unit comprising: a processor connected to the wireless receiver receiving measured acoustic data transmitted from the wireless transmitter of the data collection unit; a storage element connected to the processor storing a predetermined algorithm for processing the received measured acoustic data into coordinates representative of the geographical location of the second site.

In a further embodiment of the invention, the processor of the coordinate generating unit is coupled to the actuating system and the communication device for directing the communication unit towards the geographical location of the second site.

In an embodiment of the invention, the system further comprises a relay station located at a third site, said relay station comprising a second receiver for receiving wireless signals transmitted by the first transmitter, a second transmitter for transmitting wireless signals received from the first transmitter; and amplifying means.

In a further embodiment of the invention, the system further comprises a power supply for powering components of said system located at the first site, said power supply located at a fourth site.

In a further embodiment of the invention, the power supply comprises at least one solar panel.

In a further embodiment of the invention, the power supply is enclosed within a camouflaged housing.

In another aspect, provided is a method for covertly monitoring a plurality of sites, a first site having an retractable communication unit movable from a retracted position below ground level and a extended position above ground level, said retractable communication unit comprising a communication device, a processor coupled to a first wireless receiver and a first wireless transmitter, a second site having an acoustical sensor having a second processor coupled to a second transmitter and a third site having a third wireless receiver, said method comprising: a) receiving through the first wireless receiver located at the first site, acoustic data collected by the processor coupled to the acoustic sensor and transmitted from the second wireless transmitter located at the second site; b) telescoping the retractable communication device from the retracted position and the extended position; c) generating coordinates by processing the acoustic data with a predetermined algorithm stored in said processor, wherein the coordinates are representative of the geographical location of the second site; d) directing the communication device towards the geographical location of the second site; e) capturing video and/or audio data; f) transmitting the video and/or audio data through the second wireless transmitter; and g) receiving the video and/or audio data through the third wireless receiver located a the third site.

In another aspect, provided is a method of installing the communication system according to the invention for covert monitoring of a target area, said method comprising: providing a hole of sufficient size to receive the retractable communication unit; positioning the retractable communication unit in said hole such that the retractable communication unit is substantially located below ground level.

In an embodiment of the invention, said hole is constructed by use of a manual auger.

In a further embodiment of the invention, said hole is constructed by use of a vehicle-mounted auger.

In another aspect, provided is a method of installing a communication system for covert monitoring of a target area, said communication system comprising at least one retractable communication unit, at least one data collection unit, at least one relay stations and a monitoring unit; said method comprising: a) providing at least one hole of sufficient size to receive said retractable communication unit, said at least one hole located outside the target area; b) inserting said retractable communication unit in said hole such that the retractable communication unit is substantially below ground; c) positioning at least one data collection unit at a second site, said second site located within the target area; d) positioning the monitoring unit at a third site outside the target area; and e) positioning at least one relay station at a fourth site, said fourth site located between said first site and said third site.

### BRIEF DESCRIPTION OF THE DRAWINGS

Preferred embodiments of the invention will now be described, by way of example, with reference to the accompanying drawings, in which:

FIG. 1 is a side view of a remote communication system according to the invention, having a telescoping support and a dust collar in an extended position and a protective lid in an open position;

FIG. 2 is a cross-sectional view of an alternative embodiment of a remote communication system according to the invention, having a telescoping support and a dust collar, shown in a semi-extended position and with a protective lid in an open position;

FIG. 3 is a perspective view of the protective lid of the remote communication system of FIG. 2;

FIG. 4, is a partly broken away perspective view of an acoustic sensor, processor, and transmitter enclosed in a camouflage housing;

FIG. 5 is a flowchart illustrating the communication between the acoustic sensor and a processor, and a wireless receiver/transmitter;

FIG. 6 is a flowchart illustrating a coordinate generating unit;

FIG. 7 is a schematic view of a plurality of remote communication systems in communication with one another; and

FIG. 8 is a schematic view of a typical arrangement of a plurality of remote communication systems.

FIG. 9 is a cross-sectional view of an alternative embodiment of a remote communication system according to the invention, in near fully extended position, and having a telescoping support, a dust collar, a protective lid in an open position, and a screw jack-based extension system.

FIG. 10 is a close up view of the communication device and cover of the remote communication system of FIG. 9, showing a pan-tilt-zoom integrated robotic video camera.

FIG. 11 is a close up view of the housing, telescoping support, and screw jack assembly of the remote communication system of FIGS. 9 and 10.

Similar references are used in different figures to denote similar components.

### DESCRIPTION OF THE PREFERRED EMBODIMENTS

Communication System

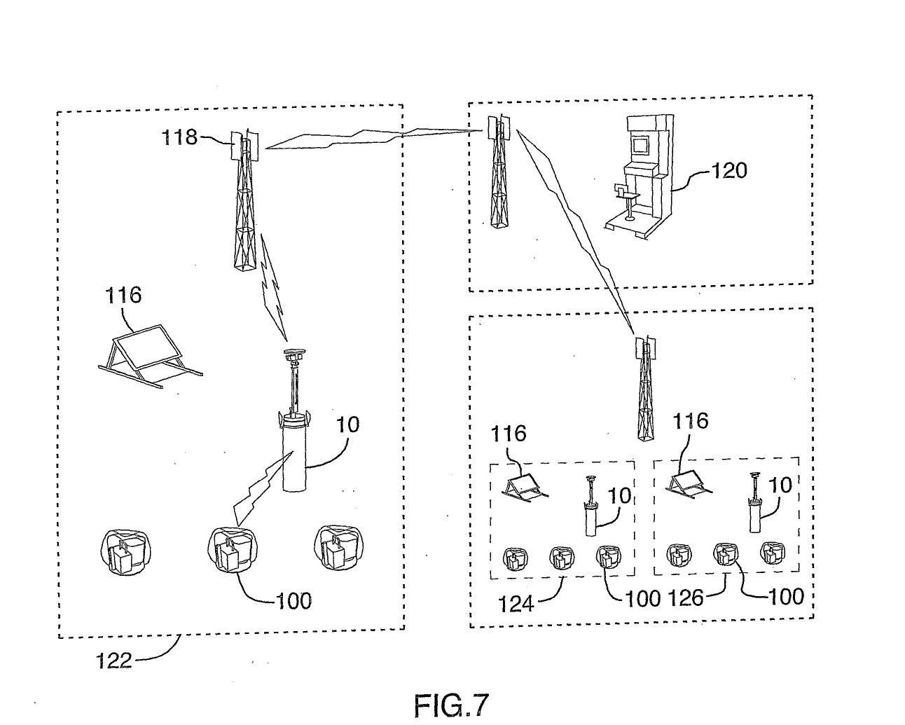

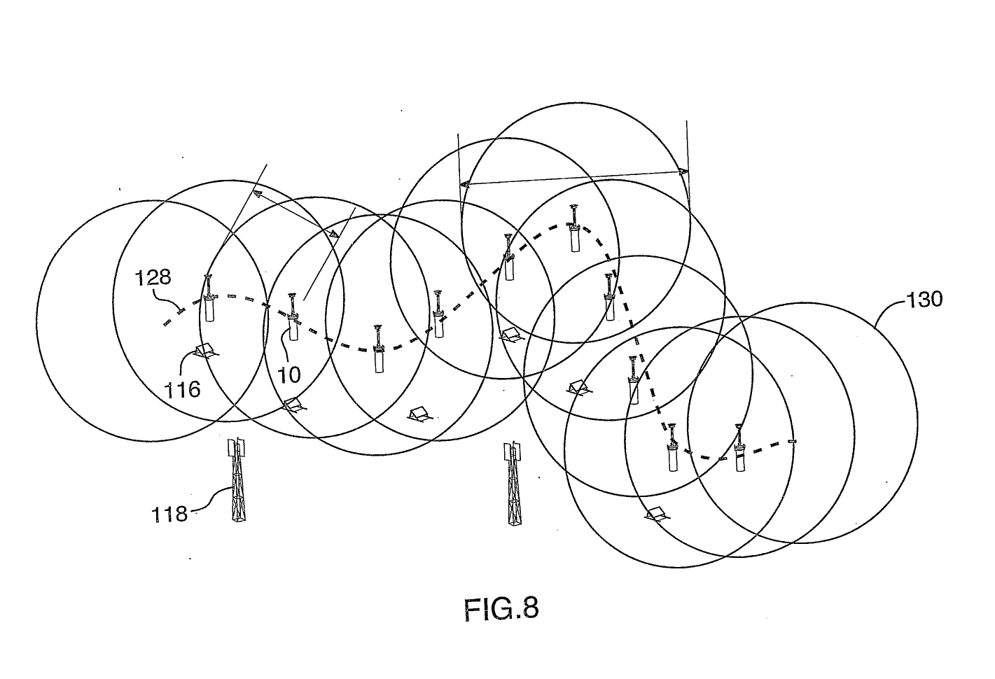

The present invention provides a communication system suitable for covertly monitoring one or more sites. As shown in FIG. 7, the communication system may comprise the following modules: a retractable communication unit 10, a data collection unit 100, power supply unit 116, a relay unit 118 and a monitoring unit 120. As the communication system is modular, it is easy to deploy and to scale up or down depending on the size of the area to be monitored. Each of the modules may be repositioned following an initial installation and reused. The system can be used to provide cost effective monitoring of remote or dangerous areas.

As the components of the communication system are installed substantially in ground and/or contained within camouflaged housings, the risk of detection of the communication system and subsequent damage or destruction of the communication system by hostile parties is substantially reduced.

The communication system provides cost-effective monitoring of remote or under populated areas. A plurality of target areas may be monitored from a single monitoring station remote from the target areas. As personal are not required at the target areas, in the case of surveillance in hostile territory or war setting, there is lowered risk of injury to civilian personnel and friendly forces. In use the system may act as a surrogate check point. An operator or guard can be located at safe distance away from potentially hostile forces.

Retractable Communication Unit

In one embodiment, the communication system comprises a retractable communication unit 10 suitable for partial or substantial in ground installation a first site located within the target area. As used herein “target area” means a predetermined geographical location in which the monitoring of activity is desired. The activity to be monitored may include movement within the area by civilian or military personal.

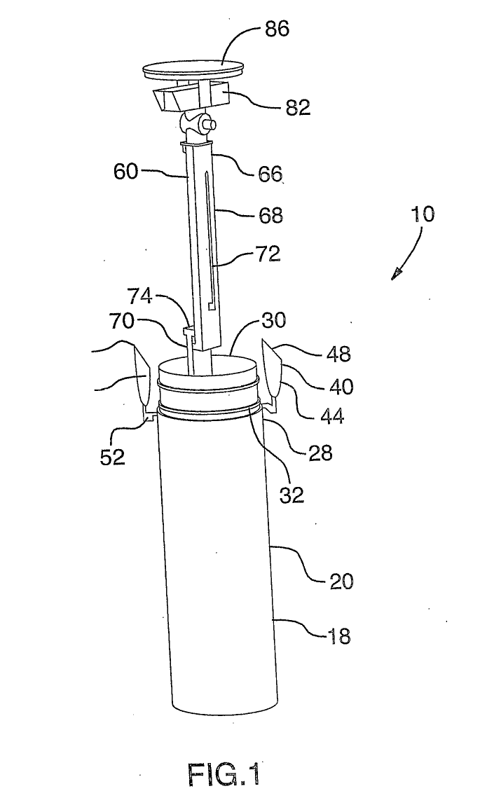

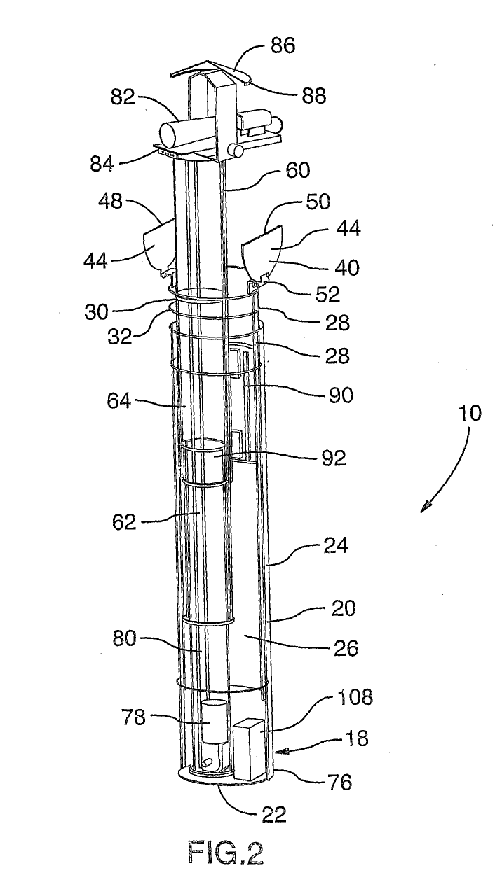

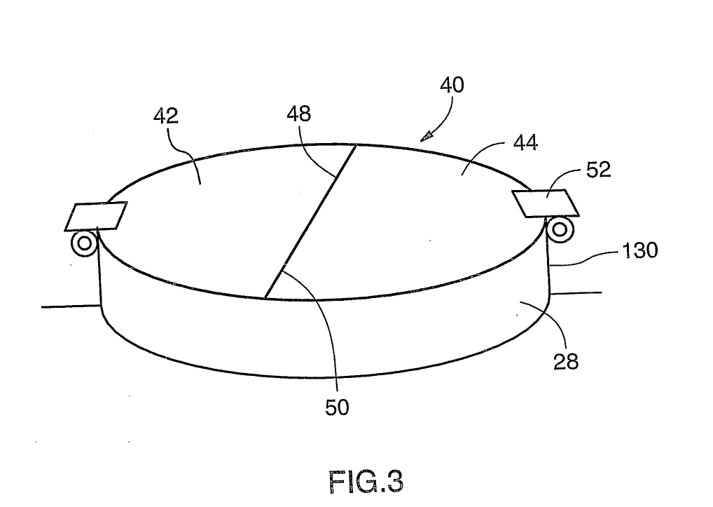

As shown in FIGS. 1 and 2, the retractable communication unit 10 may comprise a telescoping support 60; a communication device 82 mounted on a distal portion 66 of said telescoping support 60; and a housing 18 comprising a sleeve 20 having a lid 40 hinged to a distal portion of the sleeve 28. The lid 40 is movable between a closed position (as shown in FIG. 3) and an open position (as shown in FIGS. 1 and 2). The housing 18 encloses the telescoping support 60 and the communication device 82 when the telescoping support 60 is in the retracted position and when the lid 40 is in the closed position.

Materials used for constructing the housing 18 for the retractable communication unit 10 will depend on the environment in which the retractable communication unit 10 will be deployed. As the retractable communication unit 10 may be substantially installed in ground, the housing 18 is preferably water resistant and/or dust resistant. Typically the housing 18 is constructed using a water and dust resistant plastic. To enhance dust resistance, the weather resistant housing 18 may be in the form of a cylindrical sleeve 20. The housing 18 may be equipped with a tamper alarm and notification system.

The housing 18 may comprise a first sleeve 24 and second sleeve 26. As shown in FIG. 2, the second sleeve 26 nests within the first sleeve 24. The second sleeve 26 may be moved relative to the first sleeve 24 between a retracted position wherein the second sleeve 26 is nested within the first sleeve 24 and an extended position wherein the second sleeve 26 is at least partially extended beyond the first sleeve 24.

The communication device 82 is mounted to a distal portion 66 of the telescoping support 60. The telescoping support 60 comprises a fixed portion 61 which attaches to the base 22 of the housing 18 and an extendable portion 63. The telescoping support 60 may comprise a pair of nesting structures such as the cylindrical structures 62, 64 illustrated in FIG. 2. Alternatively, as shown in FIG. 1, the telescoping support 60 may comprise a pair of arms 68, 70 capable of extending longitudinally relative to each other. Each arm 68, 70 may comprise a guide 72 along which the other arm 68, 70 is slidably movable. Each arm 68, 70 may further comprise a stop 74 to prevent the detachment of the arms 68, 70 from one another.

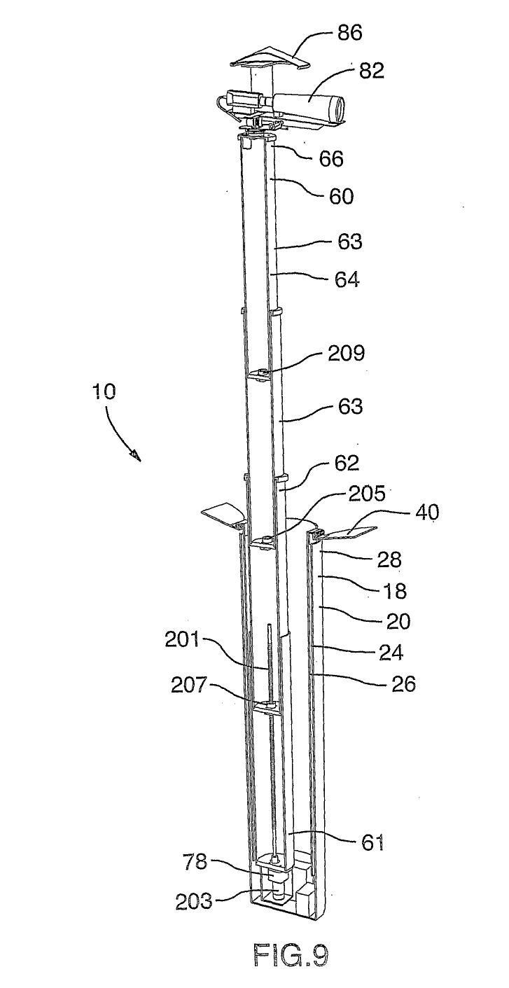

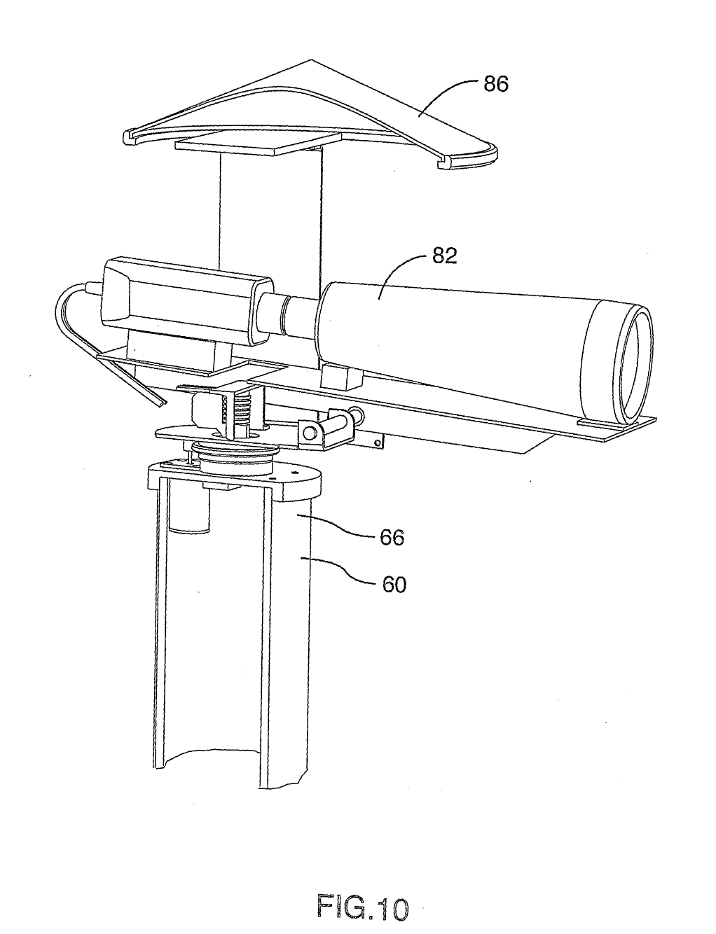

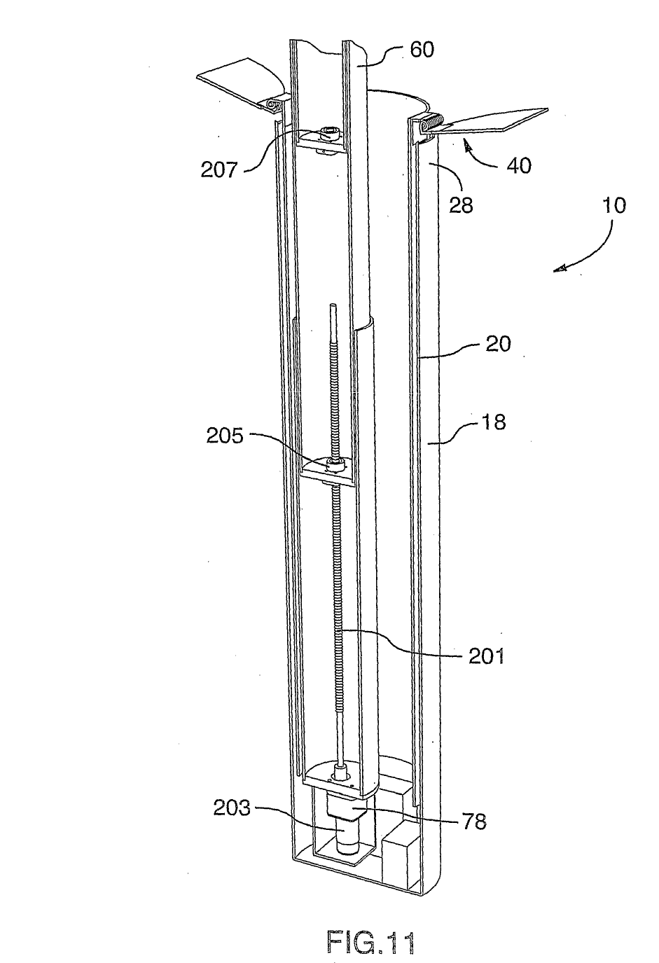

As shown in FIG. 2, an actuating system 78 is provided for moving the telescoping support 60 upward relative to the housing 18, between a retracted position, wherein the telescoping support 60 is contained within the housing and an extended position, wherein a portion of the telescoping support 60 is extended outside of the housing 18. In another embodiment, the actuating system 78 may also be used for telescoping the second sleeve 26 of the housing 18 upward relative to the first sleeve 24 of the housing 18, between a retracted position wherein the second sleeve 26 is contained within the housing and an extended position wherein a portion of the second sleeve 26 is extended outside of the housing 18. In one embodiment (as shown in FIGS. 1 and 2), the actuating system 78 is a piston 80, such as a dual stage piston capable of moving the telescoping support and the second sleeve independently. Alternatively, as shown in FIGS. 9 and 11, the actuating system is a screw jack-based system comprising a screw 201, a motor assembly 203 for rotating said screw, and a plurality of nuts 205, 207, 209, each mounted on an extendible portion of the telescoping support 60, wherein each nut departs the screw when the extendible portion on which it is mounted reaches a limit of extension. The retractable communication unit may include a battery 76 contained in the housing for powering the actuating system 78.

As shown in FIGS. 1 and 2, the housing 18 may further comprise a dust collar 30. The dust collar 30 is preferably attached to a distal portion of the housing 18. In embodiments wherein the housing 18 comprises a first sleeve 24 and second sleeve 26, the dust collar 30 is preferably attached to a distal portion 28 of the second sleeve 26. The dust collar 30 is sized and configured to transport foreign matter away from the retractable communication unit 10 during extension of the second sleeve 26 from the retracted position to the extended position.

The dust collar 30 comprises at least one seal 32 disposed around an outer surface of the dust collar 30. The seal 32 preferably has a downwardly tapered profile to facilitate the ejection of any foreign matter present on the housing. Upon elevation of the housing 18, any accumulated foreign matter such as dirt and dust will be transported down and away from the housing. The dust collar 30 may comprise a plurality of seals 32.

In use, the retractable communication unit 10 may be substantially installed in ground such that only a portion of the distal end of the housing 18 is elevated above ground level such as shown in FIG. 3. When the telescopic support 60 and/or second sleeve 26 are retracted, the dust collar 30 retracts, preferably to ground level, allowing the lid 40 to close, leaving none of the system parts substantially exposed above ground level. When the telescopic support 60 is extended, the dust collar 30 extends upwardly above ground level, preventing dust and other materials kicked or blown at just above ground level from entering the system. In deserts or similar conditions, the elevated dust collar 30 may be positioned above 90% of windborne dust which tends to hug the ground.

The retractable communication unit 10 is easily installed using conventional post augers. Typically, the retractable communication unit 10 is installed by selecting an appropriate location, digging a hole of sufficient size to accommodate the retractable communication unit 10, inserting the retractable communication unit 10 into the hole and back-filling the hole. In embodiments wherein the housing 18 is a cylindrical housing, back-filling is generally not necessary.

As shown in FIGS. 1 to 3, the housing 18 further comprises a lid 40 hinged to a distal portion 28 of the sleeve 20. The lid 40 preferably comprises first 42 and second portions 44 with each of the portions being opposably hinged to a distal portion 28 of the housing 20 which extends above the ground level when the retractable communication unit 10 is in use. Preferably, self-clearing/non-jamming hinges 52 are employed to attach the lid 40 to the housing 18.

The lid 40 is movable between a closed position (as shown in FIG. 3) and an open position (as shown in FIGS. 1 and 2). The first portion 42 and second portion 44 of the lid 40 are configured to move outwardly in opposing directions to actuate the lid 40 to the open position. As shown in FIG. 3, each of the first and second portions 42, 44 are sized to cover the opening of the housing 18 when the lid 40 is in the closed position. In a preferred embodiment, the first and second portions 42, 44 of the lid 40 are sized and configured such that they lay substantially flat with opposing edges 48, 50 of the first and second portions 42, 44 abutting one another. Opening and closing of the lid 40 may be coordinated with the extension of the dust collar 30 and/or the telescoping support 60 wherein extension of the dust collar 30 or the telescoping support 60 causes each of the first and second portions 42, 44 to be displaced outwardly to either side of the housing 18. Retraction of the dust collar 30 and/or telescoping support 60 causes each of the first and second portions 42, 44 to return the closed position. Alternatively, the lid 40 may include an independent actuating system, such as for example, remotely controlled motorized hinges, for moving the lid 40 between the open and closed position.

The outer facing surface of the lid 40 may be camouflaged. In one embodiment, an adhesive layer may be applied to the outer surface of the lid 40. The adhesive layer may be in the form of a liquid adhesive which forms a tacky layer following application. A liquid adhesive may be applied using any suitable conventional means such as brushing or spraying the adhesive onto the lid 40. The adhesive layer may also be in the form of a double-sided adhesive tape. Application of an adhesive layer to the outer surface of the lid allows the lid 40 to mimic the texture of the surrounding environment. The adhesive acts to collect and secure surrounding dust, debris, and flora surrounding the retractable communication unit. Such matter may be blown onto the adhesive layer due to wind. Alternatively, such matter may be manually applied to the adhesive layer. Alternatively, such matter may become affixed when the lid 40 swings open and contacts the adjacent ground, for example, during a first test run.

The communication device 82 may comprise a video camera, a still camera, microphone or a combination thereof for capturing live video, still images and/or audio. Preferably the communication device 82 is a pan-tilt-zoom (PTZ) robotic integrated video camera which may be remotely controlled to allow the communication device 82 to be more precisely directed to a location of interest, for example, by tilting the communication device 82 as appropriate. The retractable communication unit 10 may be adapted for low light conditions. For example, the retractable communication unit 10 may also further comprise an illuminator 84 mounted to the distal end 66 of the telescoping support 60 for enhancing image capture. In one embodiment, the camera and the illuminator may be suitable for infra-red imaging.

The communication device 82 may further comprise a two way voice communication system such as conventional two-way radio communication system. The communication device 82 may also further comprise security features to prevent tampering and unauthorized access to captured video and/or audio data. The communication device 82 may be password protected and may include a keypad unit for password input. The communication device 82 may include other security features such as a retina reader unit, a fingerprint or a card reader unit to verify identity of passers by.

As shown in FIGS. 1 and 2, the retractable communication unit 10 may further comprise a cover 86 secured over the communication unit to protect the communication device from environmental damage. Preferably, the cover 86 is sized and configured to transport foreign material such as dust and dirt away from the retractable communication unit 10 during extension of the telescoping support 60 from the retracted position to the extended position. In one embodiment, the cover 86 is conical in shape (as shown in FIG. 2) and having a lower edge 88 extending beyond the communication device 82 thereby allowing dirt and dust to be ejected away from the communication device 82, upon extension of the retractable communication unit 10.

As shown in FIGS. 7 and 8, the retractable communication system can be used to monitor one or more target areas 122, 124, 126. Activation of the retractable communication unit 10 to capture video and/or audio data may occur at regular intervals as predetermined by the user or at variable intervals as initiated by the user. Communication between the user and the retractable communication unit may be affected using a wireless cellular network. Such wireless cellular networks are well known in the art and allows for compatibility with many common monitoring systems. The retractable communication unit 10 may comprise a conventional radio frequency (RF) wireless communication system comprising a wireless receiver 90 and a wireless transmitter 92. The wireless receiver 90 and the wireless transmitter 92 may be implemented as a transceiver.

To conserve energy, the retractable communication unit 90 is capable of being maintained in a sleep mode wherein the retractable communication unit 10 is in the retracted position, and no video and/or audio data is captured by the communication device 82. The retractable communication unit 10 may be remotely switched to a wake mode wherein the communication device 82 is extended and directed towards a location of interest within the target area for monitoring activity at that location. A user may manually activate the retractable communication unit 10 by transmitting a wireless signal over the cellular network which is then received by the wireless receiver 90 of the retractable communication unit 10. Via wireless communication, the user can remotely the control the actuating system 78 and the communication device 82 of the retractable communication unit 10 in order to direct the communication device 10 towards the location of interest and to capture video and/or audio data. The wireless transmitter 92 of the retractable communication unit 10 then transmits video and/or audio data captured by the communication device 82 over the wireless cellular network to the user. If desired, the captured data may be encrypted by conventional means prior to transmission.

The retractable communication unit 10 may be programmed to automatically activate at regular or variable intervals as predetermined by the user. The user may manually activate the retractable communication unit at desired intervals.

Alternatively, activation of the retractable communication unit 10 and the capturing and transmission of video and/or audio data may be in response to the detection of a target within the target area. The detection of a target within the target area may be accomplished through the use of one or more data collection units 100 located within the target area. Data collection units 100 are discussed in further detail below. The data collection unit 100 is capable of wireless transmission of measured acoustic data. The retractable communication unit 10 may be switched between the sleep and wake modes upon receipt of the wireless transmission from the data collection unit 100. In one embodiment, the retractable communication unit 10 may further comprise a coordinate generating unit 140 (see FIG. 6) for determining the location, appearance and size of the target detected by the data collection unit 100 in order to direct the communication device 82 towards the target.

The coordinate generating unit 140 may comprise a processor 146 connected to the wireless receiver 142 of the retractable communication unit 10 which receives the measured acoustic data transmitted from the wireless transmitter 112 of the data collection unit 110. A storage element 148 is connected to the processor 146 and stores a predetermined algorithm for processing the received measured acoustic data into coordinates representative of the geographical location of the detected activity. Based on the measured frequency and the signal intensity, the coordinate generating unit can determine also determine the approximate appearance or size of the target in the target area. The processor 146 of the coordinate generating unit 140 may be coupled to the actuating system 78 and/or communication device 82 to remotely direct the communication device 78 towards the geographical location of the detected target.

Data Collection Unit

In circumstances where is it desirable to monitor a target area in response to activity occurring within the target area, the communication system may further comprise at least one data collection unit 100 located at a second site remote to the retractable communication unit 10 located at a first site. One or more data collection units 100 may be positioned in the target area to be monitored. The data collection units 100 may be used to trigger information collection by one or more retractable communication units 10. The data collection units are capable of detecting acoustical changes indicative of target activity, such as but not limited to personnel or vehicular movement, in an area proximate to the data collection unit 100.

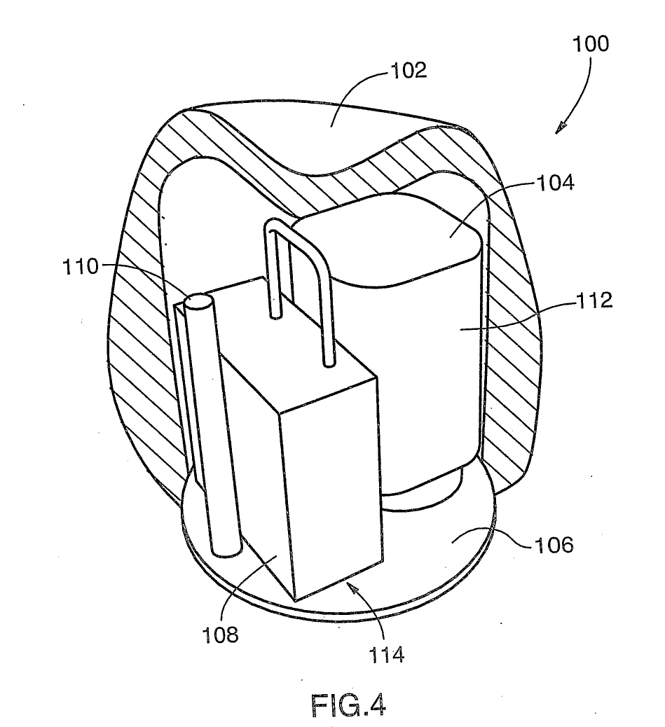

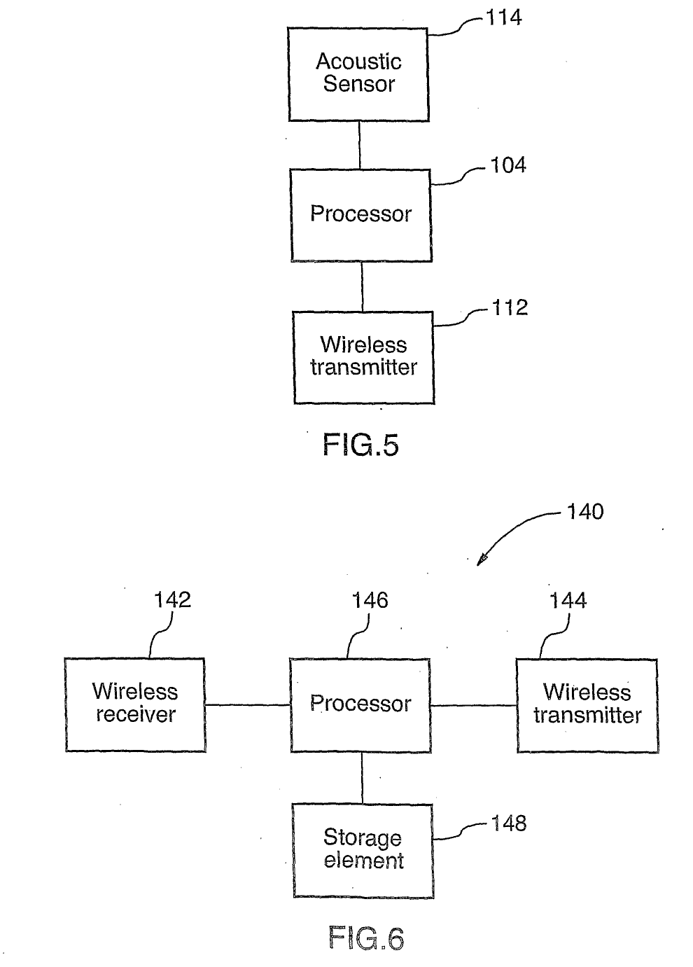

As shown in FIG. 4, the data collection unit 100 preferably comprises an acoustic sensor 114 coupled to a sensor pad 106 for measuring acoustic data. The acoustic data measured will comprise the frequency and intensity of the measured movement in the area proximate to the data collection unit 100. The acoustic sensor 114 may be configured only to measure acoustic signals within a predetermined range of frequencies. As shown in FIG. 5, a processor 104 is connected to the acoustic sensor 114 for receiving measured acoustic data. A wireless transmitter 112 is connected to the processor 104 for communicating the measured acoustic data as wireless signal over a cellular network connecting the data collection unit 100 and the retractable communication unit 10 located at the first site. The data collection unit 100 may be powered by a conventional disposal battery 108. The data collection unit may further comprise a sleep/wake switch 110 coupled to the acoustic sensor 114 and the processor 104. Prior to the detection of a frequency within the predetermined range, the data collection unit 100 may be maintained in a non-transmitting, sleep mode thereby conserving energy. Upon detection of a frequency within the predetermined range, the data collection unit 100 switches to the wake mode for collecting and transmitting acoustic data to the retractable communication unit 10.

The range of frequencies measured by the acoustic sensor 114 may be set to activate the retractable communication unit 10 in response to target movement within a predetermined distance of the data collection unit 100. The movement which may be desirably detected may include vehicular movement including civilian and military ground vehicles. The range of frequencies measured by the acoustic sensor 114 may also be set to activate the retractable communication unit 10 in response to movement of individual persons or groups thereof such as military personal. Typically, the range of frequencies will be between 4-1000 Hz.

The data collection unit 100 may be contained within a camouflaged housing 102. The type of housing 102 will depend on the environment in which the data collection unit will be deployed in. Examples of types of camouflaged housing which may be employed include but are not limited to simulated deadwood, tree stumps, fence posts and rock formed from weather resistant materials such as fiberglass.

Monitoring Unit

The retractable communications system may further comprise a monitor unit 120 located at a third site remote to a retractable communication unit located at a first site and a data collection unit located at a third site (see FIG. 7). The monitoring unit 120 may located at a safe distance away from the target areas 122, 124, 126 to lowering the risk of user to the exposure of hazards located within the target areas 122, 124, 126 such as unfriendly forces. The monitoring unit 120 includes a wireless communication system for receiving signals transmitted from one or more remote communication system via a relay station. Upon interpretation of the captured video and/or audio data, the user may activate additional retractable communication units 10 for further surveillance of other regions of the target areas 122, 124, 126.

Relay Unit

The communications system may further comprise one or more relay units 118 as part of the wireless cellular network for amplifying wireless signals communicated between the retractable communication unit 10 and the monitoring unit 120. The relay unit 118 may be a conventional antennae station including a wireless receiver, wireless transmitter and means for amplifying the wireless signals. The use of relay stations 118 increases the range in which the captured video and/or audio information can be transmitted thereby allowing the user to be situated at a greater distance away from the retractable communications unit 10 and thereby further reduces the risk of the user to hazards located within the target area.

Power Supply Unit

The communication system may further comprise a power supply 116 for powering components of a retractable communication unit 10 located at the first site, wherein the power supply 116 is located at a fourth site (see FIGS. 7 and 8). The power supply 116 unit is preferably contained or partially contained within a camouflaged housing to reduce the likelihood of detection of the power supply unit and/or the retractable communication unit. The power supply 116 may comprise any power generating source suitable for the environment in which the retractable communication system is employed. The powering generating source preferably comprises a chargeable battery and a solar panel charger. Electrical lines connecting the chargeable battery or other power generating source to the retractable communication device may be installed via a slit trench.

Method of Covertly Monitoring a Plurality of Sites

The communication system according to the invention can be used to covertly monitor one or more sites within a predetermined target area. In one embodiment, provided is method for covertly monitoring a plurality of sites, a first site having an retractable communication unit movable from a retracted position below ground level and a extended position above ground level, said retractable communication unit comprising a communication device, a processor coupled to a first wireless receiver and a first wireless transmitter, a second site having an acoustical sensor having a second processor coupled to a second transmitter and a third site having a third wireless receiver, said method comprising: a) receiving through the first wireless receiver located at the first site, acoustic data collected by the processor coupled to the acoustic sensor and transmitted from the second wireless transmitter located at the second site; b) telescoping the retractable communication device from the retracted position and the extended position; c) generating coordinates by processing the acoustic data with a predetermined algorithm stored in said processor, wherein the coordinates are representative of the geographical location of the second site; d) directing the communication device towards the geographical location of the second site; e) capturing video and/or audio data; f) transmitting the video and/or audio data through the second wireless transmitter; and g) receiving the video and/or audio data through the third wireless receiver located a the third site. The method may further comprise the use of one or more relay stations to amplify the transmitted video and/or audio data.

As shown in FIG. 4, the method according to the invention may be scaled up to monitor a plurality of target areas 122, 124, 126. Multiple retractable communication units 10 and data collection units 100 may be located in each target area 122, 124, 126 to be monitored. The communication system may be adapted such that detection of activity in first target area 122 results in the activation of a retractable communication unit 10 in second target area 124 and/or in third target area 126 to be activated and the activity in those target areas 122, 124, 126 monitored. For example, activity in a first target area 122 may result in one or more data collection units 100 switching from the energy conserving sleep mode to the wake mode as previously described and transmitting acoustic data relating to the target activity to a first retractable communication unit 10. Upon receipt of the acoustic data, the first retractable communication unit 10 switches from the energy conserving sleep mode to the wake mode in order to determine the location of the detected target and to capture video and/or audio data of the target. The video and/or audio data captured by the communication device 82 of the first retractable communication unit 10 can then be transmitted over a wireless cellular network and be received by a monitoring unit 120. The cellular network may comprise one or more relay stations. Based on the received video and/or audio data, a user may decide to activate the retractable communication units 10 in the second target area 124 and/or third target area 126 for monitoring potential target activity in those areas.

The communication system may be scaled according to monitor additional target areas. FIG. 8 illustrates a typical deployment plan wherein a plurality of retractable communication units are distributed along a protected border 128 as illustrated by the dashed line. The overlapping circles 130 illustrate the area which may be monitored a single retractable communication unit 10, wherein the radius of view is typically about one kilometer. The spacing between the retractable communication units is typically about one kilometer.

Although the invention has been described with reference to illustrative embodiments, it is to be understood that the invention is not limited to these precise embodiments, and that various changes and modifications are to be intended to be encompassed in the appended claims.

1. A communication system comprising a retractable communication unit suitable for in ground installation at a first site, said retractable communication unit comprising:
a telescoping support;
a communication device mounted on a distal portion of said telescoping support; and
a housing comprising a sleeve having a lid on a distal portion of the sleeve, said lid movable between an closed position and an open position, said housing enclosing said telescoping support and said communication device when said telescoping support is in a retracted position.

2-4. (canceled)

5. The system according to claim 1, wherein said sleeve comprises a first sleeve and a second sleeve, wherein the second sleeve is nested within the first sleeve.

6. The system according to claim 5, wherein the actuating system also moves the second sleeve upward relative to the first sleeve, between a retracted position and an extended position.

7-11. (canceled)

12. The system according to claim 5, wherein a collar is attached to a distal portion of the second sleeve, said collar sized and configured to transport foreign matter away from the system during extension of the second sleeve from the retracted position to the extended position.

13. The system according to claim 12, wherein the collar comprises at least one seal disposed around an outer surface of the collar, said seal having a tapered profile, said profile tapering upward towards the distal end of the collar.

14. The system according to claim 1, wherein the lid comprises an adhesive layer applied to an outer surface of the lid.

15. The system according to claim 14, wherein the adhesive layer is in the form of a double-sided adhesive tape, one side of said tape affixed to said other surface of said lid.

16-20. (canceled)

21. The system according to claim 1, wherein the communication device comprises a camera.

22-26. (canceled)

27. The system according to claim 1, wherein the communication device further comprises a two-way communication system.

28. (canceled)

29. The system according to claim 1, wherein the communication device further comprises one or more of a key pad unit, a retina reader unit, a fingerprint reader unit or a card reader unit.

30. The system according to claim 1, wherein the system further comprises a tamper alarm.

31. (canceled)

32. The system according to claim 1, further comprising at least one data collection unit located at a second site, wherein each data collection unit comprises:
an acoustic sensor coupled to a sensor pad for measuring acoustic data within a predetermined range of frequencies;
a professor connected to the acoustic sensor for receiving measured acoustic data;
a wireless transmitter connected to the processor for communicating the measured acoustic data to a wireless receiver located at the first site.

33. (canceled)

34. The system according to claim 32, further comprising a wireless receiver located at the first site for receiving measured acoustic data transmitted form the wireless transmitter of the data collection unit.

35. The system according to claim 34, further comprising a coordinate generating unit located at the first site; said coordinate generating unit comprising:
a processor connected to the wireless receiver receiving measured acoustic data transmitted from the wireless transmitter of the data collection unit
a storage element connected to the processor storing a predetermined algorithm for processing the received measured acoustic data into coordinates representative of the geographical location of the second site;

36. The system to claim 35, wherein the processor of the location generating unit is coupled to the actuating system and the communication device for directing the communication devices towards the geographical location of the second site.

37-40. (canceled)

41. A method for convertly monitoring a plurality of sites, a first site having an retractable communication unit movable from a retracted position below ground level and a extended position above ground level, said retractable communication unit comprising a communication device, a processor coupled to a first wireless receiver and a first wireless transmitter, a second site having an acoustical sensor having a second processor coupled to a second transmitter and a third site having a third wireless receiver, said method comprising:
a) receiving through the first wireless receiver located at the first site, acoustic data collected by the processor coupled to the acoustic sensor and transmitted from the second wireless transmitter located at the second site;
b) telescoping the retractable communication unit from the retracted position and the extended position;
c) generating coordinates by processing the acoustic data with a predetermined algorithm stored in said processor, wherein the coordinates are representative of the geographical location of the second site;
d) directing the communication device towards the geographical location of the second site;
e) capturing video and/or audio data;
f) transmitting the video and/or audio data through the second wireless transmitter; and
g) receiving the video and/or audio data through the third wireless receiver located a the third site.

42. The method according to claim 1, wherein the communication device is a camera.

43. The method according to claim 42, wherein the camera is a video camera.

44. A method of installing the communication system according to claim 1 for covert monitoring of a target area, said method comprising: providing a hole of sufficient size to receive the retractable communication unit; positioning the retractable communication unit in said hole such that the retractable communication unit is substantially located below ground level.

45. The method according to claim 44, wherein said hole in constructed by use of an auger.

46. The method according to claim 45, wherein said hole is constructed by use of a vehicle-mounted auger.

47. The method according to claim 46, wherein said vehicle auger is mounted on an armored vehicle.

48. A method of installing a communication system for covert monitoring of a target area, said communication system comprising at least one retractable communication unit, at least one data collection unit, at least one relay stations and a monitoring unit; said method comprising:
a) providing at least one hole of sufficient size to receive said retractable communication unit, said at least one hole located outside the target area;
b) inserting said retractable communication unit in said hole such that the retractable communication unit is substantially below ground;
c) positioning at least one data collection unit at a second site, said second site located within the target area;
d) positioning the monitoring unit at a third site outside the target area; and
e) positioning at least one relay station at a fourth site, said fourth site located between said first site and said third site.
